(19) United States
(12) Patent Application Publication
(10) Pub. No.: US 2025/0322420 A1
(43) Pub. Date: Oct. 16, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventor: Takuro MORI, Tokyo (JP)

(21) Appl. No.: 19/048,546

(22) Filed: Feb. 7, 2025

(30) Foreign Application Priority Data
Apr. 11, 2024 (JP) 2024-064069

(51) Int. Cl. G06Q 30/0204; G06F 40/40

(52) U.S. Cl. CPC G06Q 30/0205; G06F 40/40

(57) ABSTRACT

An information processing apparatus includes an acquisition unit that acquires user information about a user who has visited at least one of a plurality of places included in a predetermined area, an estimation unit that uses a generative model trained to output a response to an input question to extract a characteristic place included in the predetermined area as a target area, from user information acquired by the acquisition unit, and estimates a characteristic of the extracted target area, and a display unit that displays the characteristic of the target area estimated by the estimation unit.

### CROSS-REFERENCE TO RELATED APPLICATIONS

The present application claims priority to and incorporates by reference the entire contents of Japanese Patent Application No. 2024-064069 filed in Japan on Apr. 11, 2024.

### BACKGROUND OF THE INVENTION

### 1. Field of the Invention

The present invention relates to an information processing apparatus, an information processing method, and an information processing program.

### 2. Description of the Related Art

There is known a conventional art for making a store sales strategy or the like is known. For example, Patent Literature 1 proposes a technology for analysis of a trade area specified by a client device.

However, the conventional art described above merely performs analysis of the trade area. Therefore, for example, it cannot be said that the sales strategy for consideration for users in various areas is provided, in consideration of characteristic area information, in some cases.

### SUMMARY OF THE INVENTION

An information processing apparatus according to the present disclosure includes an acquisition unit that acquires user information about a user who has visited at least one of a plurality of places included in a predetermined area, an estimation unit that uses a generative model trained to output a response to an input question to extract a characteristic place included in the predetermined area as a target area, from user information acquired by the acquisition unit, and estimates a characteristic of the extracted target area, and a display unit that displays the characteristic of the target area estimated by the estimation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an exemplary configuration of a system according to a first embodiment;

FIG. 2 is a diagram illustrating an exemplary overall configuration of the system according to the first embodiment;

FIG. 3 is a block diagram illustrating an example of a functional configuration of an information processing apparatus according to the first embodiment;

FIG. 4 is a table illustrating a user information DB;

FIG. 5 is a table illustrating a facility information DB;

FIG. 6 is a table illustrating a prompt DB;

FIG. 7 is a diagram illustrating an example of a prompt used by an estimation unit according to the first embodiment;

FIG. 8 is a diagram illustrating an example of characteristics of target areas displayed on a user terminal device by a display unit according to the first embodiment;

FIG. 9 is a flowchart illustrating an exemplary process in the information processing apparatus according to the first embodiment;

FIG. 10 is a block diagram illustrating an example of a functional configuration of an information processing apparatus according to a second embodiment;

FIG. 11 is a table illustrating a user information DB;

FIG. 12 is a table illustrating a facility information DB;

FIG. 13 is a diagram illustrating an example of a prompt used by the estimation unit according to the second embodiment;

FIG. 14 is a diagram illustrating an example of characteristics of target areas displayed on a user terminal device by a display unit according to the second embodiment; and

FIG. 15 is a diagram illustrating a hardware configuration.

### DETAILED DESCRIPTION OF THE PREFERRED EMBODIMENTS

The present invention will be described through the following embodiments, but the following embodiments do not limit the invention according to the claims. All the combinations of the features described in the embodiments are not necessarily essential to means for solution of the invention.

### First Embodiment

### (Overall Configuration)

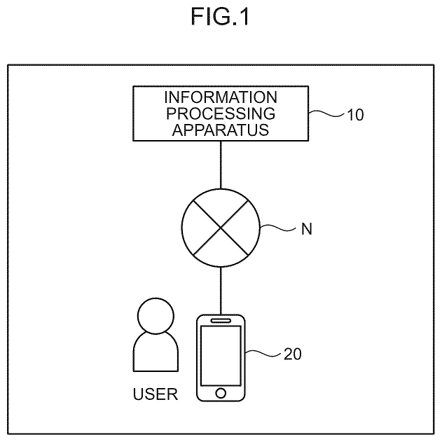

An information processing apparatus according to a first embodiment will be described. FIG. 1 is a diagram illustrating an exemplary configuration of a system according to a first embodiment; As illustrated in FIG. 1, the system according to the first embodiment includes an information processing apparatus 10, a user terminal device 20, and a network N. Note that the information processing apparatus 10 and the user terminal device 20 are not limited to the number illustrated in FIG. 1.

The information processing apparatus 10 is a device that cooperates with the user terminal device 20 to provide various services online to a service user. The information processing apparatus 10 is an example of a computer that acquires input data, generates a response using a model, outputs various information to the user terminal device 20, and executes the information.

The user terminal device 20 is an example of a terminal device used by a user. For example, the user terminal device 20 is a mobile phone, a smartphone, a tablet computer, a personal computer, or the like. Furthermore, the user terminal device 20 includes a voice input device (e.g., a microphone) that receives a voice input and a voice output device (e.g., a speaker) that outputs voice.

### (Process Executed by Information Processing Apparatus 10)

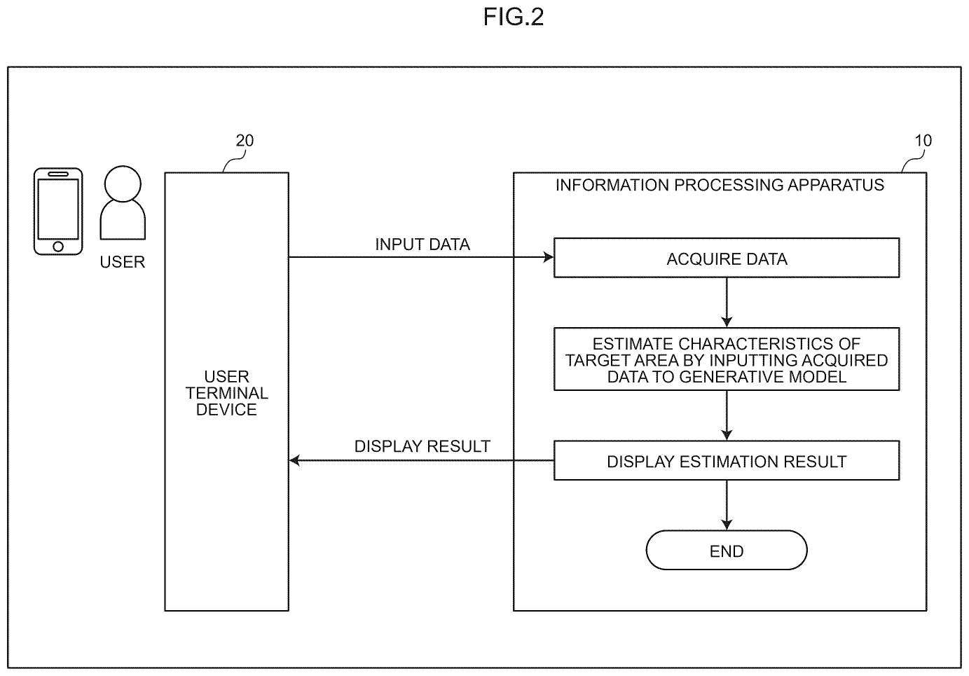

Here, a process performed by the information processing apparatus 10 will be described. FIG. 2 is a diagram illustrating an exemplary overall configuration of the system according to the first embodiment; As illustrated in FIG. 2, the information processing apparatus 10 acquires various data input from the user terminal device 20. For example, the information processing apparatus 10 acquires, but is not limited to, data such as user information, position information including a latitude and longitude, facility information visited by the user, and the like.

Next, the information processing apparatus 10 inputs the acquired data to a generative model that is trained to output an answer to an input question, and estimates the characteristics of a target area. For example, the information processing apparatus 10 inputs, to the generative model, a prompt including data about the user who has visited at least one of a plurality of places included in a predetermined area and an instruction sentence of natural language indicating an instruction for estimation of a characteristic place included in the predetermined area, from the data, as the target area, and estimates the characteristic place included in the predetermined area, as the target area. Furthermore, the information processing apparatus 10 creates and estimates a summary content by using image data and a message, for the target area to be estimated. For example, the information processing apparatus 10 estimates map data, as the image data, and estimates bulleted sentences representing the characteristics of the target area, as the message. Furthermore, the information processing apparatus 10 performs mapping on the estimated map data, and distinguishes the mapping by shape or color. Then, the information processing apparatus 10 displays the estimated image data and message on a screen of the user terminal device 20.

In other words, the information processing apparatus 10 reads data about the user information, data about the position information, and various data about the facility information, estimates the characteristics of the target area by using the generative model, and displays a result of the estimation on the user terminal device 20. As a result, the information processing apparatus 10 can visualize a range and characteristics having a certain meaning, on the map with the generative model by using the attributes, search behavior, hesitation, characteristic service, or the like of the user who has visited a certain place.

### (Functional Configuration of Information Processing Apparatus 10)

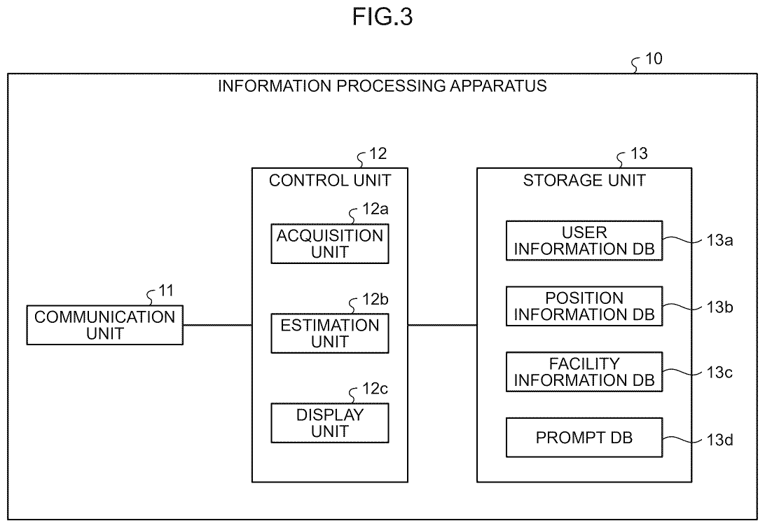

Next, a functional configuration of the information processing apparatus 10 will be described. FIG. 3 is a block diagram illustrating an exemplary functional configuration of the information processing apparatus 10 according to the first embodiment. As illustrated in FIG. 3, the information processing apparatus 10 includes a communication unit 11, a control unit 12, and a storage unit 13.

The communication unit 11 is implemented by, for example, a communication module, a network interface card (NIC), or the like. Then, the communication unit 11 is connected to the network N in a wired or wireless manner, and transmits and receives information to and from various other devices. For example, the communication unit 11 transmits and receives information between the information processing apparatus 10 and the user terminal device 20 via the network N.

The storage unit 13 is implemented by, for example, a semiconductor memory element such as a random access memory (RAM) or a flash memory, or a storage device such as a hard disk or an optical disk. The storage unit 13 includes a user information DB 13a, a position information DB 13b, a facility information DB 13c, and a prompt DB 13d.

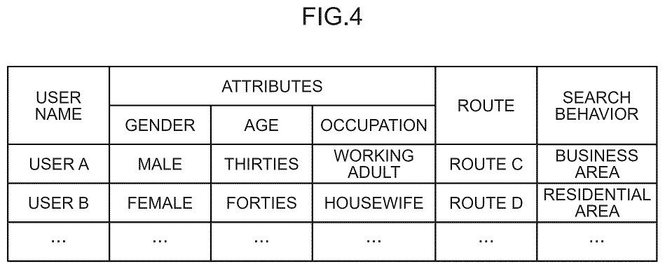

The user information DB 13a stores data about users who have visited a certain spot. FIG. 4 is a table illustrating a user information DB; As illustrated in FIG. 4, the user information DB 13a stores items of “user name”, “attributes”, “route”, and “search behavior”. Here, the stored “user name” is information for identifying a user who has made a visit. The “attributes” further includes items “gender, age, and occupation”, and is information for identifying the attributes of the user. The “route” is information for identifying a route the user has taken. The “search behavior” is information for identifying a place that the user has searched for and has moved to with the terminal device used by the user.

In the example of FIG. 4, the user information DB 13a stores “user A, male, thirties, working adult, route C, and business area” and “user B, female, forties, housewife, route D, and residential area”, as the “user name, attributes (gender, age, occupation), route, and search behavior”. In other words, the user information DB 13a stores information indicating that the “user A” who is a “male” in gender and is a “working adult” in his “thirties” has taken a “route C” toward a “business area”. Furthermore, the user information DB 13a stores information indicating that the gender of the “user B” who is a “female” and is a “housewife” in her “forties” has taken a “route D” toward a “residential area”.

Furthermore, the user information DB 13a stores information such as demographics and psychographics, as information indicating an attribute of the user. The demographics is, for example, gender, age, place of residence, place of work, occupation, or the like, and the psychographics is an object of interest such as travel, clothes, cars, or religion, a lifestyle, a tendency of thought, or the like.

The position information DB 13b stores geographic information. Examples of the geographic information include, but are not limited to, information indicating topography, information indicating a latitude and longitude, information indicating a road, information indicating a route to a public institution, information indicating traffic regulation or a road sign, information about a news article, information about disaster, information about a facility or a store, and weather information.

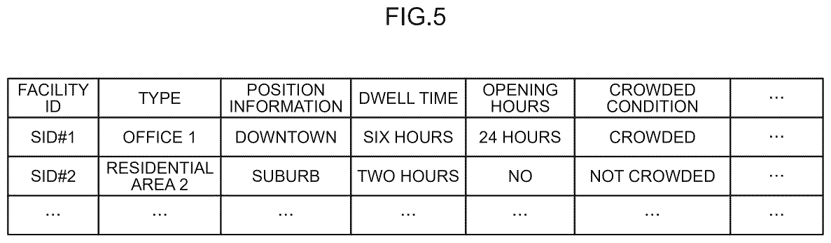

The facility information DB 13c stores data about a facility. FIG. 5 is a table illustrating a facility information DB; As illustrated in FIG. 5, the facility information DB 13c stores items of “facility ID”, “type”, “position information”, “dwell time”, “opening hours”, and “crowded condition”. Here, the stored “facility ID” indicates identification information for identifying a facility. The “type” is information for identifying the type of the facility. The “position information” is information for identifying the position (address or the like) of the facility. The “dwell time” is information for identifying the opening hours of the facility. The “crowded condition” indicates a crowded condition of the facility, and is, for example, information for identifying a time slot or the like having a crowd level equal to or larger than a predetermined threshold.

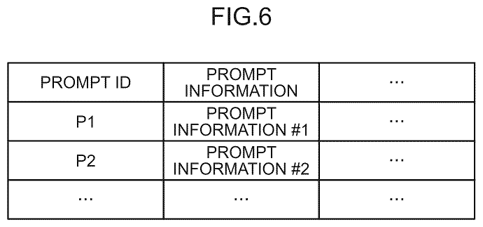

In the example of FIG. 5, the facility information DB 13c stores “SID #1, office 1, downtown, six hours, 24 hours, and crowded” and “SID #2, residential area 2, suburb, two hours, no, and not crowded”, as the “facility ID, type, position information, dwell time, opening hours, and crowded condition”. In other words, the facility information DB 13c stores information indicating that the facility ID is “SID #1”, the type of the facility is “office 1”, the place is “downtown”, the dwell time is “six hours”, the opening hours of the facility is “24 hours”, and the crowded condition is “crowded”. Furthermore, the facility information DB 13c stores information indicating that the facility ID is “SID #2”, the type of the facility is “residential area 2”, the place is “suburb”, the dwell time is “two hours”, the opening hours of the facility is “no”, and the crowded condition is “not crowded”. The prompt DB 13d stores information about prompts. FIG. 6 is a table illustrating a prompt DB; Information stored in the prompt DB 13d is used, for example, for generation of a question in pre-processing according to the first embodiment (generation of the question for learning the generative model) or change of the prompt according to the first embodiment. As illustrated in FIG. 6, the prompt DB 13d includes items such as “prompt ID” and “prompt information”. Here, the stored “prompt ID” is identification information for identifying a prompt. The “prompt information” is information included in the prompt.

In the example of FIG. 6, the prompt DB 13d stores “P1 and prompt information #1” and “P2 and prompt information #2” as the “prompt ID and prompt information”. In other words, the prompt DB 13d stores information indicating that the ID of the prompt is “P1” and information included in the prompt is “prompt information #1”. Furthermore, the prompt DB 13d stores information indicating that the ID of the prompt is “P2” and information included in the prompt is “prompt information #2”.

Next, referring back to FIG. 3, the control unit 12 of the information processing apparatus 10 will be described. The control unit 12 includes an internal memory for storing programs defining various processing procedures and the like and storing required data, thereby executing various processing. Here, the control unit 12 is, for example, an electronic circuit such as a central processing unit (CPU) or a micro processing unit (MPU), or an integrated circuit such as an application specific integrated circuit (ASIC) or a field programmable gate array (FPGA). The control unit 12 includes an acquisition unit 12a, an estimation unit 12b, and a display unit 12c.

The acquisition unit 12a acquires user information about a user who has visited at least one of a plurality of places included in a predetermined area. For example, the acquisition unit 12a acquires, as the user information, user information about a user who has moved from a predetermined place of departure to a predetermined destination via a predetermined route. Furthermore, for example, the acquisition unit 12a acquires characteristic information indicating a characteristic of each place included in the predetermined area.

The acquisition unit 12a stores the acquired information in each of the user information DB 13a, the position information DB 13b, and the facility information DB 13c.

The estimation unit 12b uses the generative model that is trained to output a response to an input question to extract a characteristic place included in the predetermined area as the target area, from the user information acquired by the acquisition unit 12a, and estimates the characteristics of the extracted target area. Furthermore, the estimation unit 12b extracts, from among places included in the predetermined area, a common place in the user information, as the target area, and estimates the characteristics of the extracted target area on the basis of the user information about the user who has visited the target area. Furthermore, for example, the estimation unit 12b extracts the target area on the basis of the characteristic information.

For example, the estimation unit 12b reads the “user A, male, thirties, working adult, route C, and business area” stored in the user information DB 13a, and estimates that the target area visited by the user A is the business area. Furthermore, for example, the estimation unit 12b reads the “user B, female, forties, housewife, route D, residential area” stored in the user information DB 13a, and estimates that the target area visited by the user B is the residential area.

Furthermore, for example, the estimation unit 12b estimates the content of the description about the user who has visited the area, as the characteristic of the target area.

For example, in estimation processing, the estimation unit 12b uses, as instruction information for instruction for estimation of a characteristic of a certain spot, instruction information for summarizing estimation results, instruction information for naming a title of the obtained summary content, instruction information for outputting the title and the summary content, and the like.

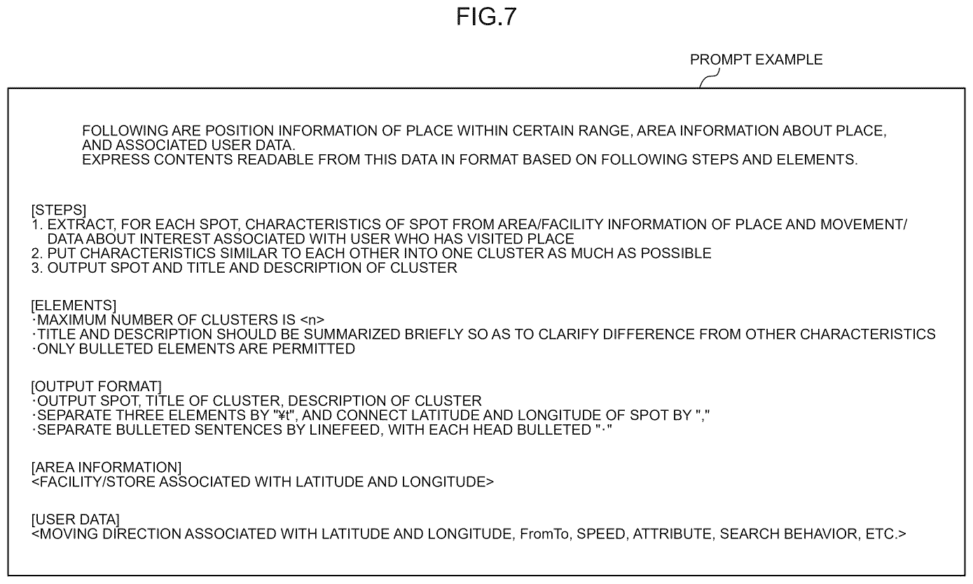

Here, the prompt used for estimation of the characteristics of the target area will be described with reference to FIG. 7. FIG. 7 is a diagram illustrating an example of the prompt used by the estimation unit 12b according to the first embodiment. For example, the estimation unit 12b inputs the prompt illustrated in FIG. 7 to the generative model, and estimates the title and the summary content of the spot by using the generative model. The instruction information about the prompt illustrated in FIG. 7 includes information about an output format indicating to “output the spot, a title of a cluster, description of the cluster”, to “separate three elements by “¥t”, and connect the latitude and longitude of spot by “,””, and to “separate bulleted sentences by linefeed, with each head bulleted “.” ”, as information about the output format that defines how to output the title and the summary content of the spot.

Specifically, the generative model that executes the prompt illustrated in FIG. 7 includes position information of a place within a certain range, area information about the place, and user data. On the basis of steps and elements, the generative model executes a process of outputting the output format.

The area information is information included in the generative model. For example, the area information is facility information or store information based on a latitude and longitude. Furthermore, for the area information, data of the position information DB 13b or the facility information DB 13c may be used.

The user data is information included in the generative model. For example, the user data is information indicating a moving direction of the user, associated with a latitude and longitude. Furthermore, the user data is information indicating a road, a distance, and a moving speed, from a point of origin to a destination point of the user. Furthermore, the user data is information indicating the attributes of the user who has visited a certain place or spot. Furthermore, the user data is information about the search behavior of the user. Furthermore, for the user data, data of the user information DB 13a may be used.

The steps executed by the generative model indicate an order and contents of processing steps to be executed. In the example of FIG. 7, steps 1 to 3 are illustrated. In step 1, for each spot, the characteristics of the spot are extracted from the area or facility information of the place, movement or behavior associated with the user who has visited the place, and data about an interest of the user. In step 2, when the characteristics of the spots are similar to each other, the characteristics are put into one cluster as much as possible. In step 3, the spot and the title and description of the cluster are output.

The elements executed by the generative model indicate conditions of the information processing described in the respective steps. As illustrated in FIG. 7, an element includes a condition that the maximum number of clusters is <n>. Furthermore, an element includes a condition that the title and the description are briefly summarized so as to clarify a difference from other characteristics. Furthermore, an element includes a condition that only bulleted elements are permitted.

The output format output by the generative model specifies a format of data to be output. The output format specifies the output of the spot, the title of the cluster, and the description of the cluster. Furthermore, the output format specifies that three elements are separated by “Yt”, and the latitude and longitude of the viewpoint is connected by “,”. Furthermore, the output format specifies that the bulleted sentences are separated by linefeed, with each head bulleted “.”.

The display unit 12c displays the characteristics of the target area estimated by the estimation unit 12b. For example, the display unit 12c displays content in which results of the estimation by the estimation unit 12b is associated with the target area. Furthermore, for example, the display unit 12c displays the characteristics of the target area estimated by the estimation unit 12b, on the user terminal device 20, as the summary content of the map data and the message.

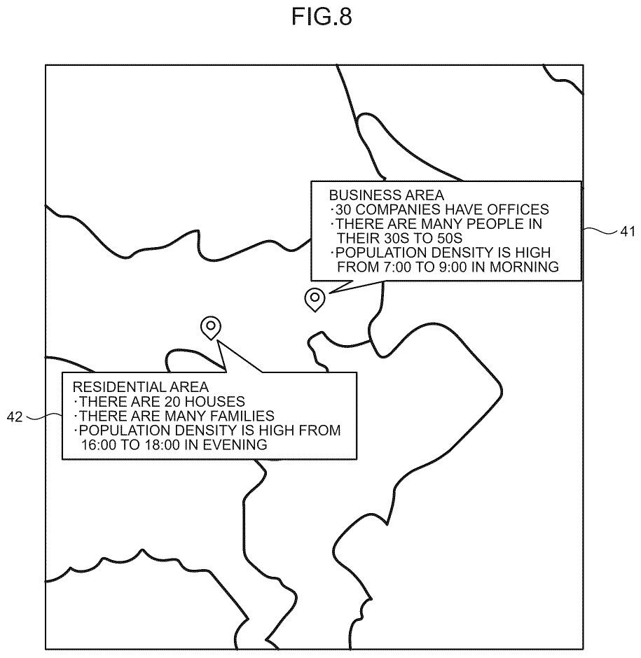

Here, the characteristics of the target area to be displayed will be described with reference to FIG. 8. FIG. 8 is a diagram illustrating an example of characteristics of the target areas displayed on the user terminal device 20 by the display unit 12c according to the first embodiment. In FIG. 8, a summary content 41 and a summary content 42 will be used for description.

The summary content 41 is information about a business area. The display unit 12c displays, as the summary content, information indicating that 30 companies have offices, there are many people in their thirties to forties in age, and population density is high from 7:00 to 9:00 in the morning. Furthermore, the summary content 42 is information about a residential area. The display unit 12c displays, as the summary content, information indicating that there are 20 houses, there live many families, and population density is high from 16:00 to 18:00 in the evening.

As described above, the information processing apparatus 10 visualizes the characteristics of a certain place on a map by using the generative model. This 10 to estimate the characteristics of a place as the summary content, for provision to the user.

### Process Procedure of First Embodiment

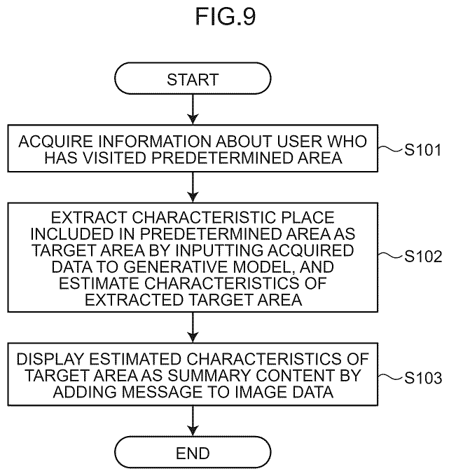

Next, an example of a process procedure by the information processing apparatus 10 according to the first embodiment will be described with reference to FIG. 9. FIG. 9 is a flowchart illustrating an exemplary process in the information processing apparatus 10 according to the first embodiment.

As illustrated in FIG. 9, the information processing apparatus 10 acquires information about the user who has visited the predetermined area from the user terminal device 20 (Step S101). Next, the information processing apparatus 10 inputs the acquired information to the generative model having been trained in advance, extracts the characteristic place included in the predetermined area as the target area, and estimates the characteristics of the extracted target area (Step S102). Then, the information processing apparatus 10 displays the estimated characteristics of the target area as the summary content by using the image data and the message (Step S103), and finishes the process.

### Effects of First Embodiment

In the first embodiment, the information processing apparatus 10 acquires the information about the user who has visited the predetermined area from the user terminal device 20, inputs the acquired information to the generative model having been trained in advance, and adds the message to the image data and displays the characteristics of the target area, and therefore, it is possible to provide the summary content of the place on the basis of the information about the characteristics of a preset place.

For example, display of the estimated characteristics of the target area as the summary content by using the image data and the message by the information processing apparatus 10 is allowed to be used for improvement of road traffic.

Furthermore, for example, display of the estimated characteristics of the target area as the summary content by using the image data and the message by the information processing apparatus 10 is allowed to be used for a store roll-out plan.

### Second Embodiment

### Overview of Second Embodiment

Incidentally, in the first embodiment, the example in which the image data and the message estimated by the generative model are displayed as map information has been described, but the information processing apparatus 10 disclosed also enables visualization of a people flow between certain spots on a map as point summary. Therefore, in a second embodiment, an example in which characteristics on a route are input to a generative model and image data and a message are displayed will be described. Note that a system configuration of the second embodiment is similar to that of FIG. 2 described in the first embodiment, and thus a detailed description thereof will not be repeated.

### (Functional Configuration of Information Processing Apparatus 10)

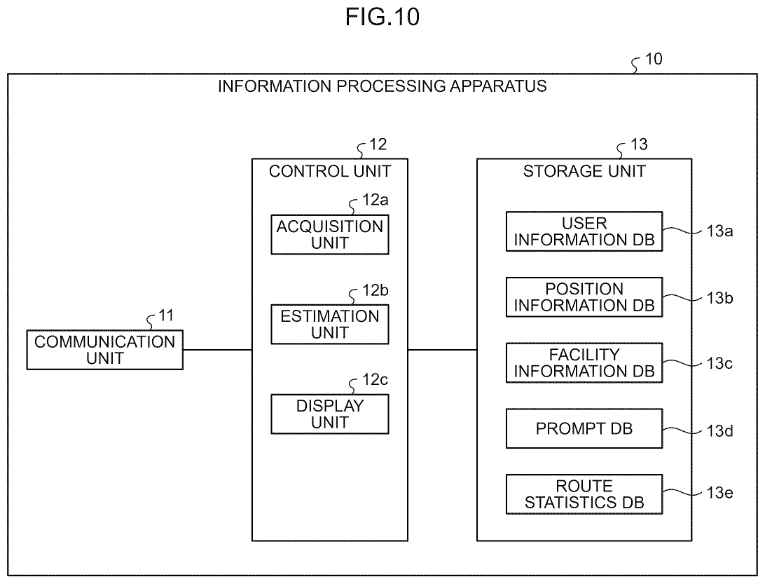

Next, a functional configuration of the second embodiment will be described. FIG. 10 is a block diagram illustrating an example of a functional configuration of the information processing apparatus 10 according to the second embodiment. The information processing apparatus 10 has configurations similar to those of the communication unit 11 and the position information DB 13b and the prompt DB 13d of the storage unit 13 illustrated in FIG. 3, and therefore, detailed description thereof will not be repeated. Here, the control unit 12 and the user information DB 13a, the facility information DB 13c, and a route statistics DB 13e of the storage unit 13, which are different from those in the first embodiment, will be described.

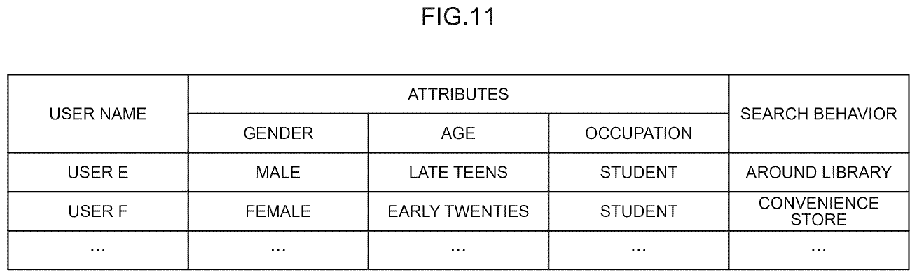

The user information DB 13a stores data about a user who has visited to a certain spot from a certain spot. FIG. 11 is a table illustrating a user information DB; As illustrated in FIG. 11, the user information DB 13a stores items of “user name”, “attributes”, and “search behavior”. Here, the stored “user name” is information for identifying a user who has made a visit. The “attributes” further includes items “gender, age, and occupation”, and is information for identifying the attributes of the user. The “search behavior” is information for identifying a place that the user has searched for and has moved to with the terminal device.

In the example of FIG. 11, the user information DB 13a stores “user E, male, late teens, student, around library” and “user B, female, early twenties, student, convenience store”, as the “user name, attributes (gender, age, occupation), and search behavior”. In other words, the user information DB 13a stores information indicating that the “user E” who is a “male” in gender and is a “student” in his “late teens” has gone to an area “around library”. Furthermore, the user information DB 13a stores information indicating that the “user B” who is a “female” in gender and is a “student” in her “early twenties” has gone to “convenience store”.

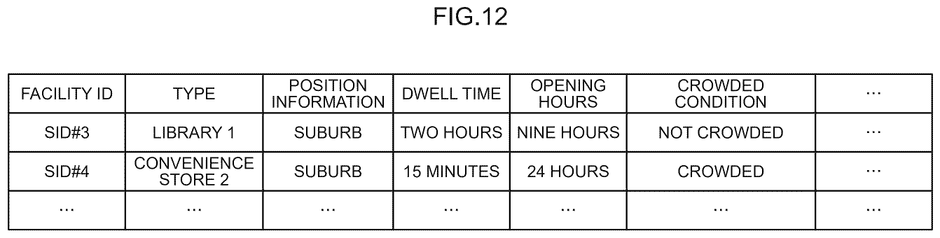

The facility information DB 13c stores data about a facility. FIG. 12 is a table illustrating a facility information DB; As illustrated in FIG. 12, the facility information DB 13c stores items of “facility ID”, “type”, “position information”, “dwell time”, “opening hours”, and “crowded condition”. Here, the stored “facility ID” indicates identification information for identifying a facility. The “type” is information for identifying the type of the facility. The “position information” is information for identifying the position (address or the like) of the facility. The “dwell time” is information for identifying the opening hours of the facility. The “crowded condition” indicates a crowded condition of the facility, and is, for example, information for identifying a time slot or the like having a crowd level equal to or larger than a predetermined threshold.

In the example of FIG. 12, the facility information DB 13c stores “SID #3, library 1, suburb, two hours, nine hours, not crowded” and “SID #4, convenience store 2, suburb, 15 minutes, 24 hours, crowded”, as the “facility ID, type, position information, dwell time, opening hours, and crowded condition”. In other words, the facility information DB 13c stores information indicating that the facility ID is “SID #3”, the facility type is “library 1”, the place is “suburb”, the dwell time is “two hours”, the opening hours of the facility is “nine hours”, and the crowded condition is “not crowded”. Furthermore, the facility information DB 13c stores information indicating that the facility ID is “SID #4”, the type of the facility is “convenience store 2”, the place is “suburb”, the dwell time is “15 minutes”, the opening hours of the facility is “24 hours”, and the crowded condition is “crowded”.

The route statistics DB 13e accumulates statistical information about a people flow. Furthermore, the route statistics DB 13e may store statistical information based on the information stored in the user information DB 13a, the position information DB 13b, and the facility information DB 13c described above. For example, statistical information such as a location (position) of a user by time of day and a percentage of users being there at that time by attribute, or a search keyword used by the user by time of day and a percentage of users having searched for the search keyword at that time by attribute, and the like may be stored.

The acquisition unit 12a acquires, as the user information, user information about a user who has moved from a predetermined place of departure to a predetermined destination via a predetermined route.

The estimation unit 12b uses the user information acquired from the acquisition unit 12a to extract a characteristic place on the predetermined route as a target area, from the user information, and estimates characteristics of the extracted target area. For example, the estimation unit 12b uses data of the statistical information about the people flow, which is stored in the route statistics DB 13e and acquired by the acquisition unit 12a, and estimates the image data and the message by using the generative model.

For example, the estimation unit 12b reads the “user E, male, late teens, student, around library” stored in the user information DB 13a, and estimates that the target area the user E has visited is around the library. Furthermore, for example, the estimation unit 12b reads the “user F, female, early twenties, student, convenience store” stored in the user information DB 13a, and estimates that the target area visited by the user F is the convenience store.

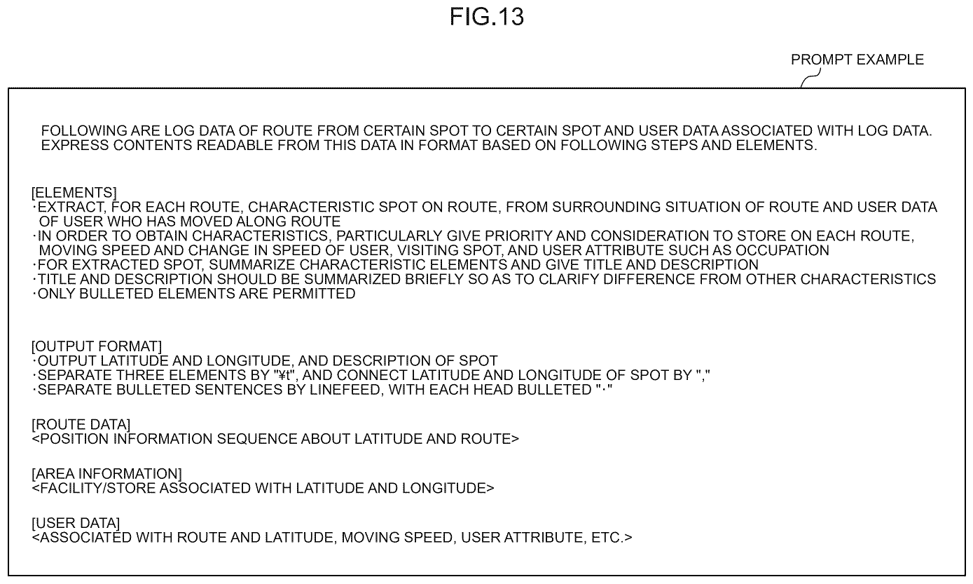

Here, a prompt used for estimation of the characteristics of the target area will be described with reference to FIG. 13. FIG. 13 is a diagram illustrating an example of the prompt used by the estimation unit 12b according to the second embodiment. For example, the estimation unit 12b inputs the prompt illustrated in FIG. 13 to the generative model, and estimates a route title and a summary content of the route by using the generative model. The instruction information about the prompt illustrated in FIG. 13 includes information about an output format indicating to “output latitude and longitude, and description of spot”, to “separate three elements by “¥t”, and connect the latitude and longitude of spot by “,””, and to “separate bulleted sentences by linefeed, with each head bulleted”. “ ”, as information about the output format that defines how to display the route title and the summary content of the route.

Specifically, the generative model that executes the prompt illustrated in FIG. 13 includes log data of a certain route and user data. On the basis of steps and elements, the generative model executes a process of outputting the output format.

Although the steps executed by the generative model are not described in detail in FIG. 13, the steps executed by the generative model, as in FIG. 7, indicate the order and contents of the process to be executed. For example, in FIG. 13, there are Steps 1 to 3. In Step 1, for each route, the characteristics of the route are extracted from area or facility information of the place, movement or behavior associated with the user who has visited the place, and data about an interest of the user. In Step 2, when the characteristics are similar to each other, the characteristics are put into one cluster as much as possible. In Step 3, the route and the title and description of the cluster are output.

The user data is information included in the generative model. For example, the user data is information indicating a moving direction of the user, associated with a latitude and longitude. Furthermore, for example, the user data is information indicating a road, a distance, and a moving speed, from a point of origin to a destination point of the user. Furthermore, for example, the user data is information indicating the attributes of the user who has visited a certain place or spot. Furthermore, for example, the user data is information about the search behavior of the user. Furthermore, for the user data, data of the user information DB 13a may be used.

Route data is information included in the generative model. For example, the route data is data of the position information about the latitude and longitude. Furthermore, for the route data, data of the position information DB 13b may be used.

The area information is information included in the generative model. For example, the area information is the facility information or store information based on a latitude and longitude. Furthermore, for the area information, the facility information DB 13c may be used.

The elements executed by the generative model indicate conditions of the information processing described in the respective steps. As illustrated in FIG. 13, an element is to extract, for each route, a characteristic spot on the route, from the surrounding situation of the route and the user data of the user who has moved along the route. Furthermore, for example, an element includes a condition that, in order to obtain characteristics, priority and consideration are particularly given to a store on each route, the moving speed and a change in speed of the user, visiting a spot, and a user attribute such as an occupation. Furthermore, for example, an element includes a condition that, for the extracted spot, characteristic elements are summarized and a title and a description are given. Furthermore, for example, an element includes a condition that only bulleted elements are permitted.

The output format output by the generative model specifies a format of data to be output. The output format specifies the output of the latitude and longitude and the description of the spot. Furthermore, the output format specifies that three elements are separated by “¥t”, and the latitude and longitude of spot is connected by “,”. Furthermore, the output format specifies that the bulleted sentences are separated by linefeed, with each head bulleted “.”.

The display unit 12c displays map information including the image and the message generated by the estimation unit 12b, on the user terminal device 20. For example, the display unit 12c displays the summary content of the route estimated by the estimation unit 12b, on the user terminal device 20.

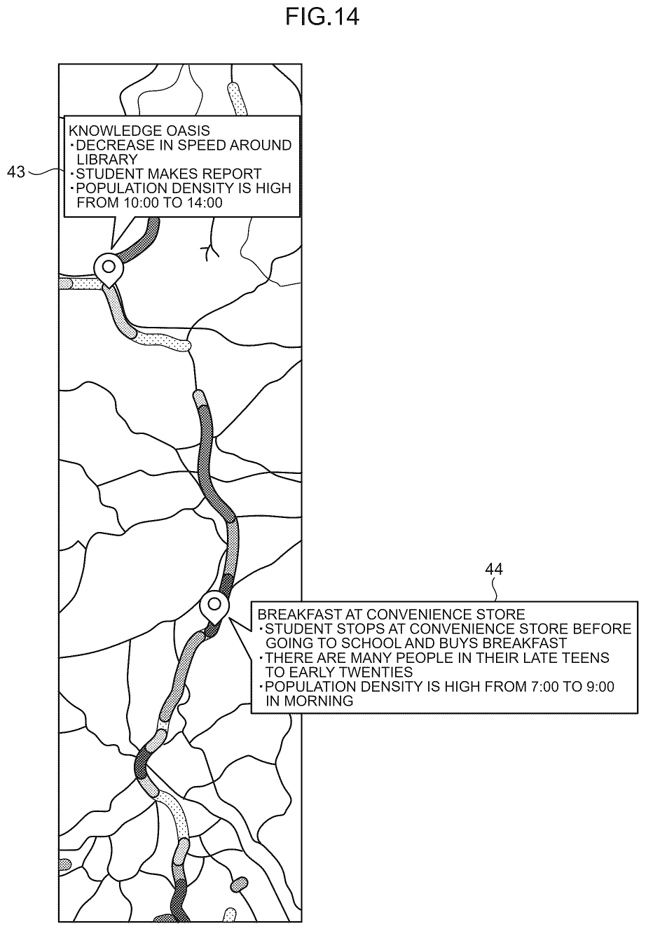

Here, the characteristics of the target area to be displayed will be described with reference to FIG. 14. FIG. 14 is a diagram illustrating an example of the characteristics of the target areas displayed on the user terminal device 20 by the display unit 12c according to the second embodiment. In FIG. 14, a summary content 43 and a summary content 44 will be used for description.

The summary content 43 is information about an area around a library. The display unit 12c displays, as the summary content, information indicating that the walking speed of the student decreases around the library, the student makes a report, and population density is high from 10:00 a.m. to 14:00. Furthermore, the summary content 44 is information about a convenience store. The display unit 12c displays, as the summary content, information indicating that the student stops at the convenience store before going to school and buys breakfast, and population density is high from 7:00 to 9:00 in the morning.

As described above, the information processing apparatus 10 visualizes the characteristics of a certain route on a map by using the generative model. This 10 to generate the characteristics of a place as the summary content, for provision to the user.

### Effects of Second Embodiment

In the second embodiment, the information processing apparatus 10 acquires predetermined information from the user terminal device 20, inputs the acquired information to the generative model having been trained in advance, estimates and the image and the message for display, and therefore, it is possible to provide the summary content of a route on the basis of the information about the characteristics of a preset place.

For example, the information processing apparatus 10 is allowed to grasp, on the basis of the summary content of the route, the behavior of a user group living in the area.

Furthermore, for example, the information processing apparatus 10 is applicable to consideration of an installation location of an advertisement such as out of home (OOH) that the user group sees in daily life, by using the summary content of the route.

Furthermore, for example, the information processing apparatus 10 enables grasping the behavior of the user group by using the summary content of the route, and therefore is allowed to be used for improvement of road traffic.

Furthermore, for example, the information processing apparatus 10 enables grasping the behavior of the user group by using the summary content of the route, and therefore is allowed to be used for a store roll-out plan of a company or the like.

### <Hardware Configuration>

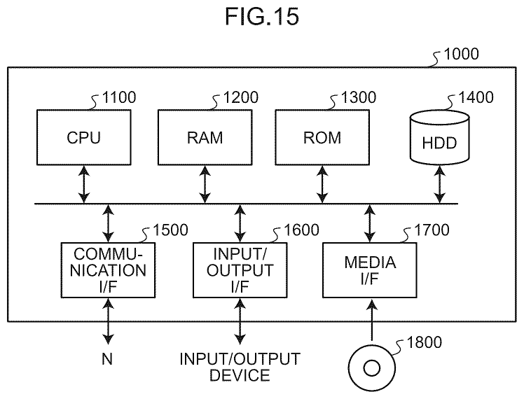

Furthermore, the information processing apparatus 100 according to the embodiments described above is implemented by, for example, a computer 1000 having a configuration as illustrated in FIG. 15. FIG. 15 is a hardware configuration diagram illustrating an example of a computer implementing the functions of the information processing apparatus 10. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates on the basis of a program stored in the ROM 1300 or the HDD 1400 to control each unit. The ROM 1300 stores a boot program executed by the CPU 1100 upon activation of the computer 1000, a program depending on hardware of the computer 1000, and the like.

The HDD 1400 stores a program executed by the CPU 1100, data used by the program, and the like. The communication interface 1500 acquires data from another device via a predetermined communication network, transmits the data to the CPU 1100, and transmits data generated by the CPU 1100 to another device via the predetermined communication network.

The CPU 1100 controls an output device such as a display or a printer, and an input device such as a keyboard or a mouse, via the input/output interface 1600. The CPU 1100 acquires data from the input device via the input/output interface 1600. Furthermore, the CPU 1100 outputs the generated data to the output device via the input/output interface 1600.

The media interface 1700 reads a program or data stored in a recording medium 1800 and provides the program or data to the CPU 1100 via the RAM 1200. The CPU 1100 loads this program from the recording medium 1800 onto the RAM 1200 via the media interface 1700, and executes the loaded program. The recording medium 1800 is, for example, an optical recording medium such as a digital versatile disc (DVD) or a phase change rewritable disk (PD), a magnetooptical recording medium such as a magneto-optical disk (MO), a tape medium, a magnetic recording medium, a semiconductor memory, or the like.

For example, when the computer 1000 functions as the information processing apparatus 10 according to an embodiment, the CPU 1100 of the computer 1000 implements the functions of the control unit 12 by executing programs loaded onto the RAM 1200. The CPU 1100 of the computer 1000 reads and executes these programs from the recording medium 1800, but in another example, these programs may be acquired from another device via the predetermined communication network.

From among the processes described in the above embodiments, all or some of processes described as being performed automatically can be performed manually, or all or some of processes described as being performed manually can be performed automatically by a known method. In addition, the processing procedure, specific name, and information including various data and parameters illustrated in the above specification and the drawings can be appropriately changed unless otherwise specified. For example, the various information illustrated in the drawings are not limited to the illustrated information.

In addition, the component elements of the respective devices are functionally conceptually illustrated, but are not necessarily physically configured as illustrated. In other words, a specific forms of distribution or integration of the devices are not limited to the illustration, and all or some thereof can be functionally or physically distributed or integrated in any units according to various loads, usage conditions, and the like.

Furthermore, the embodiments described above can be appropriately combined within a range in which the process contents have no contradiction.

Although some embodiments of the invention have been described in detail above with reference to the drawings, the embodiments are illustrative, and various modifications and changes of the invention can be made on the basis of the knowledge of those skilled in the art including the aspects described in the disclosure of the Invention.

Furthermore, the term “unit (section or module)” described above can be replaced with, for example, “means” or “circuit”. For example, the acquisition unit can be replaced with acquisition means or an acquisition circuit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an acquisition unit that acquires user information about a user who has visited at least one of a plurality of places included in a predetermined area;
an estimation unit that uses a generative model trained to output a response to an input question to extract a characteristic place included in the predetermined area as a target area, from user information acquired by the acquisition unit, and estimates a characteristic of the extracted target area; and
a display unit that displays the characteristic of the target area estimated by the estimation unit.

2. The information processing apparatus according to claim 1, wherein
the estimation unit extracts, from among places included in the predetermined area, a common place in the user information, as the target area, and estimates a characteristic of the extracted target area based on the user information about the user who has visited the target area.

3. The information processing apparatus according to claim 1, wherein
the acquisition unit acquires, as the user information, user information about a user who has moved from a predetermined place of departure to a predetermined destination via a predetermined route, and
the estimation unit extracts a characteristic place on the predetermined route as a target area, from the user information, and estimates a characteristic of the extracted target area.

4. The information processing apparatus according to claim 1, wherein
the acquisition unit further acquires characteristic information indicating a characteristic of each place included in the predetermined area, and
the estimation unit further extracts the target area based on the characteristic information.

5. The information processing apparatus according to claim 1, wherein the estimation unit estimates a content of description about the user who has visited the area, as the characteristic of the target area.

6. The information processing apparatus according to claim 1, wherein the display unit displays content in which a result of the estimation by the estimation unit is associated with the target area.

7. An information processing method comprising:
an acquisition step of acquiring user information about a user who has visited at least one of a plurality of places included in a predetermined area;
an estimation step of using a generative model trained to output a response to an input question to extract a characteristic place included in the predetermined area as a target area, from user information acquired in the acquisition step, and estimating a characteristic of the extracted target area; and
a display step of displaying the characteristic of the target area estimated in the estimation step.

8. A non-transitory computer readable storage medium storing an information processing program for causing a computer to execute:
an acquisition step of acquiring user information about a user who has visited at least one of a plurality of places included in a predetermined area;
an estimation step of using a generative model trained to output a response to an input question to extract a characteristic place included in the predetermined area as a target area, from user information acquired in the acquisition step, and estimating a characteristic of the extracted target area; and
a display step of displaying the characteristic of the target area estimated in the estimation step.
